(19) United States
(12) Patent Application Publication
(10) Pub. No.: US 2024/0301159 A1
(43) Pub. Date: Sep. 12, 2024

(54) HOLLOW PARTICLES AND APPLICATION THEREOF

(71) Applicant: MATSUMOTO YUSHI-SEIYAKU CO., LTD., Yao-shi, Osaka (JP)

(72) Inventor: Naoya TAYAGAKI, Yao-shi, Osaka (JP)

(73) Assignee: MATSUMOTO YUSHI-SEIYAKU CO., LTD., Yao-shi, Osaka (JP)

(21) Appl. No.: 18/574,858

(22) PCT Filed: Mar. 28, 2022
(86) PCT No.: PCT/JP2022/014851

§ 371 Date: Dec. 28, 2023

(30) Foreign Application Priority Data
Jul. 5, 2021 (JP) 2021-111202

(51) Int. Cl. C08J 9/18; C08J 9/228

(52) U.S. Cl. CPC C08J 9/18; C08J 9/228; C08J 2203/22; C08J 2335/04

(57) ABSTRACT

Provided are lightweight hollow particles having good handling property and dispersibility and applications thereof. The hollow particles include a thermoplastic resin shell and a hollow part surrounded by the shell, have a true specific gravity (d₁) ranging from 0.02 to 0.1, and satisfy the condition 1 shown below. The ash content of the hollow particles preferably is 2.5 wt % or less. Also disclosed is a composition containing the hollow particles and a formed product manufactured by forming the composition.

Condition 1: The true specific gravity (d₁) and an aerated bulk density (d₂) of the hollow particles satisfy the following formula (I):

$$\begin{matrix}Formula ( I ) & \\ 58 ≦ 100 \times ( {d}_{1} - {d}_{2} ) / {d}_{1} ≦ 78 . & \end{matrix}$$

### CROSS-REFERENCE TO RELATED APPLICATIONS

This application is a National Stage of International Application No. PCT/JP2022/014851 filed Mar. 28, 2022, claiming priority from Japanese Patent Application No. 2021-111202 filed Jul. 5, 2021.

### BACKGROUND OF THE INVENTION

### Field of the Invention

The present invention relates to hollow particles and application thereof.

### Description of the Related Art

Heat-expandable microspheres including a thermoplastic resin shell and a blowing agent encapsulated therein are usually called heat-expandable microcapsules. Hollow particles each including a hollow part are obtained by thermally expanding the heat-expandable microcapsules. The hollow particles are lightweight and used or tested in a wide range of application, such as lightweight fillers for adhesives and paints and an ingredient of heat insulation paints.

Such hollow particles are apt to scatter due to their lightweight property and cause poor handling property. Coating hollow particles with inorganic powder is one of the measures to improve their handling property. However, the inorganic powder on hollow particles increases the specific gravity of the hollow particles thus impairing their advantageous lightweight property.

PTL 1 discloses heat-expandable microspheres characterized in that at least 3 mass percent of the microspheres remain on a glass plate after the blower test in which the microspheres are heated and freely expanded on the glass plate by blowing air hotter than their expansion-initiation temperature. The literature discloses that the expanded particles exhibit good adhesion property between the particles and between the particles and other materials to minimize the amount of the particles dropping off and achieve good mechanical property of resultant molded products containing the expanded particles.
[PTL 1] WO 2016/088800

### Problems to be Solved by the Invention

The hollow particles obtained by thermally expanding the heat-expandable microspheres described in PTL 1, however, have been found to fuse and adhere to each other or to other materials. Furthermore, the hollow particles have excessively adhered to manufacturing facilities where the hollow particles are used and have shown poor handling property and poor dispersibility.

### SUMMARY OF THE INVENTION

It is therefore an object of the present invention to provide lightweight hollow particles having good handling property and dispersibility and to provide applications thereof in order to solve the problems mentioned above.

Following diligent study, the present inventors have discovered that hollow particles having specific properties are able to solve the above-mentioned problems and have achieved the present invention.

The hollow particles of the present invention include a thermoplastic resin shell and a hollow part surrounded by the shell, have a true specific gravity (d₁) ranging from 0.02 to 0.1, and satisfy the condition 1 shown below:

Condition 1: The true specific gravity (d₁) and an aerated bulk density (d₂) of the hollow particles satisfy the following formula (I):

$$\begin{matrix}Formula ( I ) & \\ 58 ≦ 100 \times ( {d}_{1} - {d}_{2} ) / {d}_{1} ≦ 78 . & \end{matrix}$$

The ash content of the hollow particles of the present invention preferably is 2.5 wt % or less.

The hollow particles of the present invention preferably have a mean particle size ranging from 1 to 100 μm.

The thermoplastic resin constituting the hollow particles of the present invention preferably is a polymer of a polymerizable component containing a nitrile monomer.

The hollow particles of the present invention preferably satisfy the condition 2 shown below:

Condition 2: The pH of the aqueous dispersion prepared by dispersing 1 wt % of the hollow particles in ion-exchanged water is higher than 7 at 25° C.

The composition of the present invention includes the hollow particles and a base material.

The formed product of the present invention is manufactured by forming the composition.

### Advantageous Effects of the Invention

The hollow particles of the present invention are lightweight and have good handling property and dispersibility.

The composition of the present invention is uniform, stable and lightweight owing to the hollow particles included.

The formed product of the present invention manufactured by forming the composition is lightweight.

### BRIEF DESCRIPTION OF THE DRAWINGS

FIG. 1: A schematic diagram of an example of the hollow particles

FIG. 2: A schematic diagram of the expansion unit of a device for manufacturing hollow particles by dry thermal expansion

### REFERENCE NUMBERS LIST

Reference numbers used to identify various features in the drawings include the following:
1 Shell
2 Hollow part
8 Hot air nozzle
9 Refrigerant flow
10 Overheat prevention jacket
11 Distribution nozzle
12 Collision plate
13 Gas fluid containing heat-expandable microspheres
14 Gas flow
15 Hot airflow

### DETAILED DESCRIPTION OF PREFERRED EMBODIMENTS

The hollow particles of the present invention include a thermoplastic resin shell and a hollow part surrounded by the shell. The hollow particles of the present invention are specifically described as follows and in reference to the drawings. However, the present invention should not be construed as being limited thereto.

### Hollow Particles

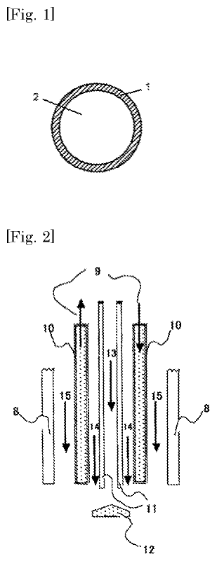

The hollow particles of the present invention include a thermoplastic resin shell and a hollow part surrounded by the shell as in the example shown in FIG. 1. The hollow particles are nearly spherical and have a hollow part therein which forms a large cavity inside the particles. The shape of the particles can be exemplified by a soft tennis ball.

The hollow particles of the present invention can be expansion products of the heat-expandable microspheres mentioned below.

The shell of the hollow particles has continuous form having outer and inner surfaces without edges. The thickness of the shell, in other words, the distance between the outer and inner surfaces, should preferably be uniform though it can be non-uniform.

The hollow part of the hollow particles is basically filled with a gas though it can contain a liquid. A hollow particles should preferably have a single hollow part though it can have a plurality of hollow parts.

The true specific gravity (d₁) of the hollow particles of the present invention ranges from 0.02 to 0.1. The hollow particles having a true specific gravity (d₁) within the range are sufficiently lightweight. The hollow particles having a true specific gravity (d₁) lower than 0.02 are more apt to scatter and have poor handling property. The upper limit of the true specific gravity (d₁) preferably is 0.095, more preferably 0.09, and further more preferably 0.085. The lower limit of the true specific gravity (d₁) preferably is 0.025, more preferably 0.028, and further more preferably 0.030.

The true specific gravity (d₁) of the hollow particles was determined by the method described in the Examples herein.

The hollow particles of the present invention satisfy the condition 1 shown below.

The hollow particles having the true specific gravity (d₁) described above and satisfying the following condition 1 do not strongly agglomerate or adhere to each other by fusing nor become excessively fluid to be isolated but form an aggregate loosely cohered and isolable by weak external force. Such hollow particles have good handling property and dispersibility because their scattering, fusing and adhesion are controllable.

Condition 1: The true specific gravity (d₁) and aerated bulk density (d₂) of the hollow particles satisfy the following formula (I):

$$\begin{matrix}Formula ( I ) & \\ 58 ≦ 100 \times ( {d}_{1} \cdot {d}_{2} ) / {d}_{1} ≦ 78 . & \end{matrix}$$

The hollow particles having a value of Formula (I) lower than 58 are lightweight and excessively fluid to be isolated. Such particles are apt to scatter and have poor handling property. On the other hand, the hollow particles having a value of Formula (I) higher than 78 strongly agglomerate or adhere to each other by fusing to cause increased adhesion on facility surface and have poor handling property and dispersibility. The upper limit of the value of Formula (I) preferably is 77, more preferably 76, further more preferably 75, yet further more preferably 73, and most preferably 71. On the other hand, the lower limit of the value of Formula (I) preferably is 60, more preferably 61, further more preferably 63, and most preferably 65.

The aerated bulk density (d₂) of the hollow particles of the present invention is not specifically restricted and preferably ranges from 0.0045 to 0.05. The aerated bulk density (d₂) of 0.0045 or more results in improved dispersibility of the hollow particles. On the other hand, the aerated bulk density (d₂) of 0.05 or lower results in improved handling property of the hollow particles. The upper limit of the aerated bulk density (d₂) preferably is 0.04 and more preferably 0.035. On the other hand, the lower limit of the aerated bulk density (d₂) preferably is 0.0055, more preferably 0.007, and further more preferably 0.0085.

The aerated bulk density (d₂) of the hollow particles was determined by the method described in the Examples herein.

The ash content of the hollow particles of the present invention is not specifically restricted and preferably is 2.5 wt % or lower. The hollow particles having the ash content of 2.5 wt % or lower form an aggregate loosely cohered and isolable by weak external force to attain better effect of the present invention. The upper limit of the ash content preferably is (1) 2.3 wt %, (2) 2 wt %, (3) 1.7 wt %, (4) 1.5 wt %, (5) 1 wt %, (6) 0.8 wt %, or (7) 0.5 wt %, where the amount with a greater number in the parentheses is more preferable. On the other hand, the lower limit of the ash content preferably is 0 wt %, more preferably 0.1 wt % and further more preferably 0.2 wt %.

The ash content of the hollow particles of the present invention means the ignition residue of the hollow particles and the ash content was determined by the method described in the Examples herein.

The hollow particles of the present invention is not specifically restricted and preferably satisfy the condition 2 shown below:

Condition 2: The pH of the aqueous dispersion prepared by dispersing 1 wt % of the hollow particles in ion-exchanged water is higher than 7 at 25° C.

If the pH of the aqueous dispersion in the condition 2 is higher than 7 at 25° C., the hollow particles are easily controlled to form isolable aggregates. The upper limit of the pH preferably is 14, more preferably 12, further more preferably 10.5, and most preferably 10. On the other hand, the lower limit of the pH preferably is 7.2, more preferably 7.5, further more preferably 8, and most preferably 8.5.

The pH at 25° C. was measured by the method described in the Examples herein.

The mean particle size of the hollow particles of the present invention is not specifically restricted and preferably ranges from 1 to 100 μm. The hollow particles having a mean particle size within the range have better handling properties, such as decreased scattering and adhesiveness and have better dispersibility. The upper limit of the mean particle size preferably is 80 μm, more preferably 60 μm, and most preferably 50 μm. On the other hand, the lower limit of the mean particle size preferably is 10 μm, more preferably 15 μm, further more preferably 20 μm, and most preferably 22 μm.

The mean particle size of the hollow particles was determined by the method in the Examples herein.

The coefficient of variation, CV, of the particle size distribution of the hollow particles of the present invention is not specifically restricted, and preferably is not greater than 45%, more preferably not greater than 40%, and most preferably not greater than 35%. The hollow particles having a coefficient of variation greater than 50% can have increased contact points with other hollow particles because of the hollow particles with different particle sizes existing in the aperture of other hollow particles. The increased contact points accelerate the agglomeration or adhesion of the hollow particles. The lower limit of the coefficient of variation, CV, preferably is 3%, more preferably 5%, and further more preferably 10%. The coefficient of variation, CV, is calculated by the following formulae (1) and (2).

$$\begin{matrix}[ Formulae 1 ] & \\ C V = ( s / < x > ) \times 100 ( \% ) & ( 1 )\end{matrix}$$

$$s = {\{ {\sum }_{i = 1}^{n} {( xi - < x > )}^{2} / ( n - 1 ) \}}^{1 / 2} \qquad ( 2 )$$

where “s” is a standard deviation of the particle size of the microspheres, <x> is a mean particle size of the microspheres, “xi” is the particle size of the i-th particle, and “n” represents the number of particles.

The ratio (r1/r2) of the thickness of the shell (r₁) of the hollow particles of the present invention to their mean particle size (the above-mentioned mean particle size, r₂) is not specifically restricted and preferably ranges from 0.001 to 0.01 for attaining sufficient lightness of the hollow particles.

The shell of the hollow particles of the present invention includes a thermoplastic resin. Although the thermoplastic resin is not specifically restricted, the resin preferably is a polymer of a polymerizable component which contains monomers having a polymerizable carbon-carbon double bond per molecule and can contain a monomer having at least two polymerizable carbon-carbon double bonds per molecule as a cross-linking agent.

The monomers contained in the polymerizable component include, for example, nitrile monomers such as acrylonitrile, methacrylonitrile, fumaronitrile and maleonitrile; vinyl halide monomers, such as vinyl chloride; vinylidene halide monomers, such as vinylidene chloride; vinyl ester monomers, such as vinyl acetate, vinyl propionate and vinyl butyrate; carboxyl-group-containing monomers, such as unsaturated monocarboxylic acids including acrylic acid, methacrylic acid, ethacrylic acid, crotonic acid and cinnamic acid, unsaturated dicarboxylic acids including maleic acid, itaconic acid, fumaric acid, citraconic acid and chloromaleic acid, anhydrides of unsaturated dicarboxylic acids, and monoesters of unsaturated dicarboxylic acids including monomethyl maleate, monoethyl maleate, monobutyl maleate, monomethyl fumarate, monoethyl fumarate, monomethyl itaconate, monoethyl itaconate and monobutyl itaconate; (meth)acrylate monomers, such as methyl (meth)acrylate, ethyl (meth)acrylate, n-butyl (meth)acrylate, t-butyl (meth)acrylate, 2-ethylhexyl (meth)acrylate, stearyl (meth)acrylate, phenyl (meth)acrylate, isobornyl (meth)acrylate, cyclohexyl (meth)acrylate, benzyl (meth)acrylate and 2-hydroxyethyl (meth)acrylate; (meth)acrylamide monomers, such as acrylamide, substituted acrylamide, methacrylamide and substituted methacrylamide; maleimide monomers, such as N-phenyl maleimide and N-cyclohexyl maleimide; styrene monomers, such as styrene and α-methyl styrene; ethylenically unsaturated monoolefin monomers, such as ethylene, propylene and isobutylene; vinyl ether monomers, such as vinyl methyl ether, vinyl ethyl ether and vinyl isobutyl ether; vinyl ketone monomers, such as vinyl methyl ketone; N-vinyl monomers, such as N-vinyl carbazole and N-vinyl pyrrolidone; vinyl naphthalene salts; and dialkyl itaconates, such as dimethyl itaconate and dibutyl itaconate. Apart of or the whole of the carboxyl groups of the carboxyl-group-containing monomers can be neutralized during or after the polymerization.

Acrylic acids and methacrylic acids can be collectively referred to as (meth)acrylic acids. The word, (meth)acryl, means acryl or methacryl, and the word (meth)acrylate, means acrylate or methacrylate.

One of or a combination of at least two of the monomers can be used.

The polymerizable component preferably contains a nitrile monomer for improved heat resistance and gas barrier effect of the shell of the resultant hollow particles. The amount of the nitrile monomer in the polymerizable component is not specifically restricted and preferably ranges from 15 wt % to 100 wt %. The upper limit of the amount preferably is 99.9 wt %, more preferably 99.5 wt %, further more preferably 99 wt %, and most preferably 98.5 wt %. On the other hand, the lower limit of the amount preferably is 20 wt %, more preferably 30 wt %, further more preferably 40 wt %, and most preferably 50 wt %.

The nitrile monomer contained in the polymerizable component preferably contains acrylonitrile and/or methacrylonitrile and preferably contains acrylonitrile for improved mechanical strength of the shell of the resultant hollow particles.

If the nitrile monomer contains acrylonitrile, the amount of acrylonitrile in the polymerizable component preferably ranges from 40 wt % to 100 wt %, though the amount is not specifically restricted. The upper limit of the amount preferably is 95 wt %, more preferably 90 wt %, further more preferably 85 wt %, and most preferably 80 wt %. On the other hand, the lower limit of the amount preferably is 50 wt %, more preferably 55 wt %, and further more preferably 60 wt %.

The nitrile monomer preferably contains acrylonitrile (AN) and/or methacrylonitrile (MAN) for improved density of the shell of the resultant hollow particles.

If the nitrile monomer contains AN and MAN, the ratio by weight of AN to MAN (AN:MAN) preferably ranges from 40:60 to 99:1, though the ratio is not specifically restricted. The upper limit of the ratio by weight preferably is 90:10, more preferably 87:13 and further more preferably 80:20. On the other hand, the lower limit of the ratio by weight preferably is 50:50, more preferably 55:45 and further more preferably 60:40.

The polymerizable component preferably contains a carboxyl-group-containing monomer as the monomer component for improved heat resistance and solvent resistance of the shell of the resultant hollow particles.

If the polymerizable component contains the carboxyl-group-containing monomer, the amount of the carboxyl-group-containing monomer in the polymerizable component preferably ranges from 10 wt % to 80 wt %, though the amount is not specifically restricted. The upper limit of the amount preferably is 70 wt %, more preferably 60 wt %, further more preferably 50 wt %, and most preferably 45 wt %. On the other hand, the lower limit of the amount preferably is 15 wt % and more preferably 20 wt %.

The polymerizable component preferably contains a (meth)acrylate ester as the monomer component for adjusting the glass-transition temperature of the shell of the hollow particles and adjusting the production condition of the hollow particles. The amount of the (meth)acrylate ester in the polymerizable component preferably ranges from 0 wt % to 70 wt %. The upper limit of the amount preferably is 60 wt %, more preferably 50 wt %, further more preferably 35 wt %, and most preferably 20 wt %. On the other hand, the lower limit of the amount preferably is 0.2 wt %, more preferably 0.5 wt %, further more preferably 0.7 wt %, and most preferably 1 wt %.

The polymerizable component preferably contains a vinylidene halide monomer for improving the gas barrier effect of the resultant thermoplastic resin. The amount of the vinylidene halide monomer in the polymerizable component is not specifically restricted and preferably ranges from 0 wt % to 70 wt %. The upper limit of the amount preferably is 60 wt %, more preferably 50 wt %, further more preferably 35 wt % and most preferably 20 wt %. The lower limit of the amount preferably is 0.2 wt %, more preferably 0.5 wt %, further more preferably 0.7 wt % and most preferably 1 wt %.

As mentioned above, the polymerizable component can contain a cross-linking agent. The polymerizable component containing a cross-linking agent is preferable for improved density of the resultant thermoplastic resin and for improved expansion performance, heat resistance and mechanical strength of the resultant hollow particles.

The cross-linking agent includes, for example, aromatic divinyl compounds, such as divinylbenzene; and polyfunctional (meth)acrylate compounds, such as allyl methacrylate, triacrylformal, triallyl isocyanate, ethylene glycol di(meth)acrylate, diethylene glycol di(meth)acrylate, triethylene glycol di(meth)acrylate, neopentylglycol dimethacrylate, polytetramethylene glycol diacrylate, 1,4-butanediol di(meth)acrylate, 1,6-hexanediol di(meth)acrylate, 1,9-nonanediol di(meth)acrylate, PEG (200) di(meth)acrylate, PEG (400) di(meth)acrylate, PEG (600) di(meth)acrylate, trimethylolpropane trimethacrylate, pentaerythritol tri(meth)acrylate, pentaerythritol tetraacrylate, dipentaerythritol hexaacrylate, 2-butyl-2-ethyl-1,3-propanediol diacrylate and tricyclodecane dimethanol di(meth)acrylate. One of or a combination of at least two of the cross-linking agents can be used.

The polymerizable component may not contain a cross-linking agent. The amount of the cross-linking agent in the polymerizable component is not specifically restricted and preferably ranges from 0.01 parts by weight to 10 parts by weight to 100 parts by weight of the monomer component in the polymerizable component. The lower limit of the amount preferably is 0.1 parts by weight, more preferably 0.3 parts by weight and further more preferably 0.5 parts by weight. The upper limit of the amount preferably is 6 parts by weight, more preferably 3.5 parts by weight, further more preferably 1.6 parts by weight, and most preferably 1.1 parts by weight.

### Process for Manufacturing Hollow Particles

The process for manufacturing the hollow particles of the present invention includes the steps, for example, step 1 (expansion step) in which heat-expandable microspheres including a thermoplastic resin shell and a thermally vaporizable blowing agent encapsulated in the shell are expanded by heating. The heat-expandable microspheres are prepared before the expansion step, and the process for producing the heat-expandable microspheres includes, for example, step 2 (polymerization step) in which an oily mixture containing the polymerizable component and blowing agent is dispersed in an aqueous dispersion medium and the polymerizable component is polymerized with a polymerization initiator. Thus the hollow particles are produced through the steps of polymerization and expansion in this order.

The hollow particles of the present invention should preferably be manufactured through the step of thermally expanding the heat-expandable microspheres to efficiently manufacture the hollow particles.

### Polymerization Step

For the blowing agent mentioned above, any agents which thermally vaporize can be used. Examples of the blowing agent include C₃-C₁₃ hydrocarbons, such as propane, (iso)butane, (iso)pentane, (iso)hexane, (iso)heptane, (iso)octane, (iso)nonane, (iso)decane, (iso)undecane, (iso)dodecane and (iso)tridecane; hydrocarbons having a carbon number greater than 13 and not greater than 20, such as (iso)hexadecane and (iso)eicosane; hydrocarbons from petroleum fractions such as pseudocumene, petroleum ether, and normal paraffins and isoparaffins having an initial boiling point ranging from 150° C. to 260° C. and/or being distilled at a temperature ranging from 70° C. to 360° C.; halides of C₁-C₁₂ hydrocarbons, such as methyl chloride, methylene chloride, chloroform and carbon tetrachloride; fluorine-containing compounds, such as hydrofluoroether; silanes having C₁-C₅alkyl groups, such as tetramethyl silane, trimethylethyl silane, trimethylisopropyl silane and trimethyl-n-propyl silane; and compounds which thermally decompose to generate gases, such as azodicarbonamide, N,N′-dinitrosopentamethylenetetramine and 4,4′-oxybis(benzenesulfonyl hydrazide). The blowing agent can be composed of one of or a combination of at least two of those compounds. The blowing agent can be any of linear, branched or alicyclic compounds, and preferably is aliphatic compounds.

In the polymerization step, the polymerizable component is polymerized into the thermoplastic resin constituting the shell of the heat-expandable microspheres.

The polymerizable component preferably is polymerized in the presence of a polymerization initiator. The polymerization initiator preferably is contained in the oily mixture along with the polymerizable component and blowing agent.

The polymerization initiator is not specifically restricted, and includes, for example, peroxides, such as peroxydicarbonates, peroxyesters and diacyl peroxides; and azo compounds, such as azo nitriles, azo esters, azo amides, azo alkyls and polymeric azo initiators. One of or a combination of at least two of the polymerization initiators can be employed. The polymerization initiator preferably is an oil-soluble polymerization initiator which is soluble in the polymerizable component.

The amount of the polymerization initiator is not specifically restricted, and preferably ranges from 0.05 parts by weight to 10 parts by weight to 100 parts by weight of the polymerizable component, more preferably from 0.1 part by weight to 8 parts by weight and further more preferably from 0.2 parts by weight to 5 parts by weight.

In the polymerization, a chain transfer agent can be contained in the oily mixture.

The aqueous dispersion medium contains water, such as ion-exchanged water, as the main component, and the oily mixture is dispersed therein. The aqueous dispersion medium can further contain alcohols, such as methanol, ethanol and propanol, and hydrophilic organic solvents, such as acetone. The hydrophilic property mentioned in the present invention means a property of a substance optionally miscible in water. The amount of the aqueous dispersion medium used in the step is not specifically restricted, and preferably ranges from 100 parts by weight to 1000 parts by weight to 100 parts by weight of the polymerizable component.

The aqueous dispersion medium can further contain an electrolyte, such as sodium chloride, magnesium chloride, calcium chloride, sodium sulfate, magnesium sulfate, ammonium sulfate, and sodium carbonate. One of or a combination of at least two of these electrolyte can be used. The amount of the electrolyte is not specifically restricted, and preferably ranges from 0.1 part by weight to 50 parts by weight to 100 parts by weight of the aqueous dispersion medium.

The aqueous dispersion medium can contain at least one water-soluble compound selected from the group consisting of potassium dichromate, alkali metal nitrite salts, metal (III) halides, boric acid, water-soluble ascorbic acids, water-soluble polyphenols, water-soluble vitamin Bs, water-soluble phosphonic acids and phosphonate salts, polyalkylene imines having a nitrogen atom bonded with an alkyl group substituted with a hydrophilic functional group selected from the group consisting of carboxylic acid (salt) groups and phosphonic acid (salt) groups, and water-soluble 1,1-substitution compounds having a carbon atom bonded with a hetero atom and with a hydrophilic functional group selected from the group consisting of hydroxyl group, carboxylic acid (salt) groups and phosphonic acid (salt) groups. The term “water-soluble” in the present invention means that at least 1 g of a substance is soluble in 100 g of water.

The amount of the water-soluble compound contained in the aqueous dispersion medium is not specifically restricted, and preferably ranges from 0.0001 part by weight to 1.0 part by weight to 100 parts by weight of the polymerizable component, more preferably from 0.0003 parts by weight to 0.1 part by weight, and most preferably from 0.001 part by weight to 0.05 parts by weight.

The aqueous dispersion medium can contain a dispersion stabilizer or dispersion stabilizing auxiliary in addition to the electrolytes and water-soluble compounds.

The dispersion stabilizer is not specifically restricted, and includes, for example, calcium triphosphate; magnesium pyrophosphate and calcium pyrophosphate produced by double decomposition reaction; colloidal silica; alumina sol; and magnesium hydroxide. One of or a combination of at least two of those dispersion stabilizers can be used.

The amount of the dispersion stabilizer preferably ranges from 0.05 parts by weight to 100 parts by weight to 100 parts by weight of the polymerizable component, and more preferably from 0.2 parts by weight to 70 parts by weight.

The dispersion stabilizing auxiliary is not specifically restricted, and includes, for example, polymeric dispersion stabilizing auxiliaries; and surfactants, such as cationic surfactants, anionic surfactants, amphoteric surfactants and nonionic surfactants. One of or a combination of at least two of those dispersion stabilizing auxiliaries can be used.

The aqueous dispersion medium is prepared by optionally blending an electrolyte, a water-soluble compound, a dispersion stabilizer and a dispersion stabilizing auxiliary with water (ion-exchanged water). The pH of the aqueous dispersion medium during polymerization is adjusted depending on the variants of the water-soluble compound, dispersion stabilizer, and dispersion stabilizing auxiliary.

The polymerization can be carried out in the presence of sodium hydroxide or a combination of sodium hydroxide and zinc chloride.

In the polymerization step, the oily mixture is dispersed and suspended in the aqueous dispersion medium to be formed into oil globules of a prescribed particle size.

The methods for dispersing and suspending the oily mixture include generally known dispersion techniques, such as agitation with a homogenizing mixer (for example, a device manufactured by PRIMIX Corporation), dispersion with a static dispersing apparatus such as a Static mixer (for example, a device manufactured by Noritake Engineering Co., Ltd.), membrane suspension technique, and ultrasonic dispersion.

The suspension polymerization is then started by heating the dispersion in which the oily mixture is dispersed into oil globules in the aqueous dispersion medium. During the polymerization reaction, the dispersion should preferably be agitated gently to prevent the floating of monomers and sedimentation of polymerized heat-expandable microspheres.

The polymerization temperature can be set optionally depending on the variant of the polymerization initiator, and preferably is adjusted within the range from 30° C. to 100° C., and more preferably from 40° C. to 90° C. The polymerization temperature preferably is maintained for about 1 hour to 20 hours. The initial pressure for the polymerization is not specifically restricted, and preferably is controlled within the range from OMPa to 5 MPa in gauge pressure, and more preferably from 0.2 MPa to 3 MPa.

The resultant slurry is filtered with a centrifugal separator, press filter or vacuum dehydrator to be processed into a cake with a water content ranging from 10 wt % to 50 wt %, preferably from 15 wt % to 45 wt % and more preferably from 20 wt % to 40 wt %. The cake is dried in a tray drier, an indirect heating oven, a fluidized bed dryer, a vacuum dryer, a vibration dryer or a flash dryer to be processed into dry powder with a moisture content not greater than 5 wt %, preferably not greater than 3 wt % and more preferably not greater than 1 wt %.

The slurry can also be dried with a spray dryer or a fluidized bed dryer to be processed into dry powder.

As described above, heat-expandable microspheres including a thermoplastic resin shell and a thermally-vaporizable blowing agent encapsulated therein are produced.

The mean particle size of the heat-expandable microspheres produced in the polymerization step is not specifically restricted and preferably ranges from 1 μm to 75 μm, more preferably from 2 μm to 50 μm, further more preferably from 3 μm to 40 μm, yet further more preferably from 5 μm to 35 μm and most preferably from 7 μm to 30 μm.

The true specific gravity of the heat-expandable microspheres produced in the polymerization step preferably ranges from 0.97 to 1.30 and more preferably from 1.05 to 1.20. The heat-expandable microspheres having a true specific gravity within the range tend to be efficiently processed into the hollow particles of the present invention.

### Expansion Step

The expansion step means the step in which the heat-expandable microspheres produced in the polymerization step is thermally expanded. The method for the expansion is not specifically restricted so far as the heat-expandable microspheres can be thermally expanded, and either dry thermal expansion or wet thermal expansion can be employed.

An example of the dry thermal expansion is the method disclosed in Japanese Patent Application Publication 2006-213930, in particular the internal injection method. An example of the wet thermal expansion is the method disclosed in Japanese Patent Application Publication 1987-201231. The preferable temperature for thermally expanding the heat-expandable microspheres ranges from 80° C. to 450° C.

The hollow particles of the present invention, which are expanded heat-expandable microspheres, can have further expansion performance. The further expansion performance means the property of the hollow particles to further expand (re-expand) by heating.

The further expansion ratio of the hollow particles is not specifically restricted and preferably ranges from 18% to 85%. Hollow particles having a further expansion ratio lower than 18% are apt to frequently contact with each other and the thermal load on the particles becomes excessive in expansion step. Such hollow particles can strongly agglomerate or adhere to each other by fusing to cause increased adhesion on facility surface and have poor handling property and dispersibility. On the other hand, hollow particles having a further expansion ratio higher than 85% cannot be processed into sufficiently lightweight hollow particles and fail to attain sufficient lightweight effect. The upper limit of the further expansion ratio preferably is 80%, more preferably 70%, further more preferably 65%, and most preferably 60%. On the other hand, the lower limit of the further expansion ratio preferably is 25%, more preferably 30%, and most preferably 40%. The further expansion ratio of heat-expandable microspheres is usually 95% or higher.

The further expansion ratio represents the degree of the re-expansion of hollow particles which are re-expanded to the maximum. The further expansion ratio is calculated by the following formula (3) from the true specific gravity of hollow particles (d₁) and the true specific gravity of the re-expanded hollow particles (d).

$$Further expansion ratio ( \% ) = ( 1 - {d}_{A} / {d}_{1} ) \times 100 \qquad ( 3 )$$

When hollow particles having further expansion performance are re-expanded to the maximum, the hollow particles are in the limit state of retaining the blowing agent which has been encapsulated in heat-expandable microspheres and thermally vaporized while the heat-expandable microspheres are thermally expanded into the hollow particles.

The hollow particles of the present invention, which are the expansion product of heat-expandable microspheres, can contain the blowing agent. The content of the blowing agent in the hollow particles is not specifically restricted and preferably ranges from 0.5 wt % to 25 wt %. The upper limit of the content preferably is 20 wt %, more preferably 15 wt %, further more preferably 12 wt % and most preferably 10 wt %. On the other hand, the lower limit of the content preferably is 1 wt %, more preferably 2 wt %, and further more preferably 3 wt %. The content of the blowing agent in the hollow particles mean the weight percentage of the blowing agent in the hollow particles.

The product containing heat-expandable microspheres or hollow particles obtained by the method mentioned above contains the components other than the heat-expandable microspheres or hollow particles, such as electrolytes, water-soluble compounds, dispersion stabilizers and dispersion stabilizing auxiliaries. The components can be eliminated or their amount can be controlled to a certain level.

The dispersion containing hollow particles or heat-expandable microspheres can be obtained by dispersing hollow particles or heat-expandable microspheres in a liquid dispersion medium, such as water, or by dispersing a slurry after the polymerization step containing heat-expandable microspheres or a slurry after the expansion step containing hollow particles.

The electrolytes, water-soluble compounds and dispersion stabilizing auxiliaries are soluble in water and their amount can be adjusted by washing the hollow particles, heat-expandable microspheres or the above-mentioned wet cake of heat-expandable microspheres.

The amount of the dispersion stabilizers, which are hardly soluble inorganic compounds, can be adjusted by converting them into water-soluble inorganic compounds by acid-base reaction (pH adjustment reaction) through pH adjustment to remove them from the surface of hollow particles and heat-expandable microspheres (pH adjustment process). After the pH adjustment process, the amount of the hardly soluble inorganic compounds can be adjusted through the steps of removing the dispersion medium by filtration and washing the resultant heat-expandable microspheres or hollow particles with water.

The pH of aqueous dispersion medium containing heat-expandable microspheres and a hardly soluble basic inorganic compound, such as magnesium hydroxide or calcium carbonate, as the dispersion stabilizer, is adjusted with an acidic compound, such as a mineral acid including sulfuric acid or hydrochloric acid, to 2.0 to 5.0 so as to change the hardly soluble basic inorganic compounds into water-soluble inorganic compounds, such as magnesium sulfate, magnesium chloride and calcium chloride. The pH of aqueous dispersion medium containing a hardly soluble acidic inorganic compound, such as colloidal silica, is adjusted with a basic compound, such as sodium hydroxide or potassium hydroxide, to preferably 9.5 or higher, more preferably 10 or higher, further more preferably 10.5 or higher and yet further more preferably 11 or higher so as to change the gelled colloidal silica into water-soluble silicate salt.

In the pH adjustment, the aqueous dispersion medium can be heated to accelerate the change of the hardly soluble inorganic compound into water-soluble compound by the acid-base reaction. The pH adjustment changes the dispersion stabilizer on the surface of heat-expandable microspheres into a water-soluble inorganic compound which can be removed from the heat-expandable microspheres together with water-soluble compounds and dispersion-stabilizing auxiliaries by washing with water. Thus the ash content of the hollow particles and heat-expandable microspheres is adjusted.

The pH adjustment can be carried out after the polymerization step or the expansion step. The pH adjustment preferably is carried out after the polymerization step to efficiently produce the hollow particles of the present invention.

### Compositions and Formed Products

The composition of the present invention contains the hollow particles mentioned above and a base component.

The base component includes, for example, rubbers, such as natural rubbers, butyl rubber, silicone rubber and ethylene-propylene-diene rubber (EPDM); thermosetting resins, such as unsaturated polyester resins, epoxy resins and phenolic resins; waxes, such as polyethylene waxes and paraffin waxes; thermoplastic resins, such as ethylene-vinyl acetate copolymer (EVA), ionomers, polyethylene, polypropylene, polyvinyl chloride (PVC), acrylic resin, thermoplastic polyurethane, acrylonitrile-styrene copolymer (AS resin), acrylonitrile-butadiene-styrene copolymer (ABS resin), polystyrene (PS), polyamide resin (nylon 6, nylon 66 etc.), polycarbonate, polyethylene terephthalate (PET), polybutylene terephthalate (PBT), polyacetal (POM) and polyphenylene sulfide (PPS); thermoplastic elastomers, such as olefin elastomers and styrene elastomers; bioplastics, such as polylactic acid (PLA), cellulose acetate, PBS, PHA and starch resins; sealing materials, such as silicones, modified silicones, polysulfides, modified polysulfides, urethanes, acrylates, polyisobutylenes and butyl rubbers; paint components, such as urethane polymers, ethylene-vinyl acetate copolymers, vinyl chloride polymers and acrylate polymers; and inorganic materials, such as cement, mortar and cordierite. One of or a combination of at least two of those base components can be used.

The composition of the present invention can contain other components optionally selected according to the application in addition to the hollow particles and base component.

The composition of the present invention is prepared by mixing the base component and hollow particles. The composition of the present invention is also prepared by mixing a base component with the mixture prepared by mixing the base component and hollow particles.

The hollow particles of the present invention is lightweight and have good handling property and dispersibility to enable the preparation of a uniform, stable and lightweight composition.

The amount of the hollow particles in the composition of the present invention is not specifically restricted and preferably ranges from 0.1 parts by weight to 20 parts by weight to 100 parts by weight of a base component. The amount within the range enables the preparation of a lightweight composition while maintaining the advantageous properties of the base component. The upper limit of the amount preferably is 15 parts by weight, more preferably 13 parts by weight and further more preferably 10 parts by weight. On the other hand, the lower limit of the amount preferably is 0.3 parts by weight, more preferably 0.5 parts by weight and further more preferably 1.0 part by weight.

The hollow particles and a base component are mixed with machines, such as a kneader, a roller kneader, a mixing roller, a mixer, a single screw extruder, a twin screw extruder or a multi-screw extruder.

The composition of the present invention is used as, for example, a molding composition, a paint composition, a clay composition, a fiber composition, an adhesive composition and a powder composition.

The formed product of the present invention is manufactured by forming the composition mentioned above. The formed product of the present invention includes, for example, molded products and coatings.

The formed product of the present invention has lightweight property, porosity, sound absorbency, thermal insulation property, low thermal conductivity, permittivity-decreasing property, design potential, shock absorbing performance, and strength, which have been efficiently improved.

### EXAMPLES

The hollow particles of the present invention are specifically described with the following Examples. The present invention is not restricted within the scope of those Examples. In the following Examples and Comparative Examples, “%” means “wt %” and “part(s)” means “part(s) by weight” unless otherwise specified.

The properties of the heat-expandable microspheres and hollow particles in the following Examples of production, Examples and Comparative Examples were measured and the performance of those microspheres and particles were tested and evaluated in the procedures mentioned below.

### Determination of Average Particle Size and Particle Size Distribution of Heat-Expandable Microspheres

A sample of heat-expandable microspheres was analyzed with a Microtrac particle size analyzer manufactured by Nikkiso Co., Ltd. (9320-HRA) to determine the mean volume diameter D₅₀, which was defined as the average particle size of the microspheres.

### Mean Particle Size and Particle Size Distribution of Hollow Particles

A sample of hollow particles was analyzed in dry system with a laser diffraction particle size analyzer manufactured by Malvern (MASTRSIZER 3000,). The mean volume diameter D₅₀ determined in the analysis was defined as the mean particle size.

Determination of the Expansion-Initiation Temperature (Tₛ) and the Maximum Expansion Temperature (Tₘₐₓ) of Heat-Expandable Microspheres

The maximum expansion temperature was determined with a DMA (DMA Q800, manufactured by TA Instruments). In an aluminum cup (4.8 mm deep and 6.0 mm in diameter), 0.5 mg of a sample of heat-expandable microspheres was placed, and the layer of the microspheres was covered with an aluminum cap (5.6 mm in diameter and 0.1 mm thick) to prepare a test sample. The test sample was set on the device and subjected to the pressure of 0.01 N with the compression unit of the device, and the height of the sample was measured. The sample was then heated by elevating the temperature at the rate of 10° C./min from 20° C. to 300° C., being subjected to the pressure of 0.01 N with the compression unit, and the change in the height of the sample was measured. The temperature at which the height started to increase was determined as the expansion-initiation temperature (Tₛ) and the temperature at which the compression unit indicated the highest position was determined as the maximum expansion temperature (Tₘₐₓ).

### Ash (Ignition Residue) Content

A dried sample was placed in a crucible in an amount of Wp g and heated with an electric heater at 700° C. for 30 min to be ignited into ash, and the weight of the resultant ash, Wq (g), was measured. The ash content in the sample, CA (wt %), was calculated from Wp (g) and Wq (g) by the following formula.

$${C}_{A} ( wt \% ) = ( Wq / Wp ) \times 100$$

The ash content of each sample of heat-expandable microspheres and hollow particles was determined. The samples with moisture content of not higher than 1% were used for the determination.

### Moisture Content

The moisture content of heat expandable microspheres and hollow particles was determined with a Karl Fischer moisture meter (MKA-510N, manufactured by Kyoto Electronics Manufacturing Co., Ltd.). The moisture content of heat-expandable microspheres was represented by C_{w1}.

### Content of a Blowing Agent in Heat-Expandable Microspheres

In a stainless-steel evaporating dish (15 mm deep and 80 mm in diameter), 1.0 g of a sample of heat-expandable microspheres was placed and weighed out (W₁ (g)). Then 30 mL of acetonitrile was added to disperse the microspheres uniformly. After being left for 24 hours at room temperature, the sample was dried under reduced pressure at 130° C. for 2 hours, and the dry weight (W₂ (g)) was determined. The content (hereinafter sometimes referred to as encapsulation ratio) (C₁) of the blowing agent in the heat-expandable microspheres was calculated by the following formula:

$${C}_{1} ( wt \% ) = 100 \times \{ 100 \times ( {W}_{1} - {W}_{2} ) / 1. \cdot {C}_{w 1} \} / ( 100 \cdot {C}_{w 1} )$$

where the moisture content of the heat-expandable microspheres, C_{w1}, was measured by the method mentioned above.

### True Specific Gravity (d₁) of Hollow Particles

The true specific gravity (d₁) of the hollow particles was determined by the following procedure.

Specifically, the true specific gravity of the hollow particles was determined by the liquid substitution method (Archimedean method) with isopropyl alcohol in an atmosphere at 25° C. and 50% RH (relative humidity) as described below.

At first, an empty 100-mL measuring flask was dried and weighed (W_{B1} (g)). Then isopropyl alcohol was poured into the weighed measuring flask accurately to form meniscus, and the measuring flask filled with isopropyl alcohol was weighed (W_{B2} (g)).

The 100-mL measuring flask was then emptied, dried, and weighed (W_{S1} (g)). About 50 mL of the hollow particles with moisture content adjusted below 1% were placed in the weighed measuring flask, and the measuring flask containing the hollow particles was weighed (W_{S2} (g)). Then isopropyl alcohol was poured into the measuring flask containing the hollow particles to form meniscus accurately without taking bubbles into the isopropyl alcohol, and the flask containing the hollow particles and isopropyl alcohol was weighed (W_{S3} (g)). The values, W_{B1}, W_{B2}, W_{S1}, W_{S2}, and W_{S3}, were introduced into the following formula to calculate the true specific gravity (d₁) of the hollow particles.

$${d}_{1} = [ ( {W}_{S 2} - {W}_{S 1} ) \times ( {W}_{B 2} - {W}_{B 1} ) / 100 ] / [ ( {W}_{B 2} - {W}_{B 1} ) ( {W}_{S 3} - {W}_{S 2} ) ]$$

### Aerated Bulk Density (d₂) of Hollow Particles

The aerated bulk density (d₂) of hollow particles was determined by the following method.

A stainless-steel 100-mL cylindrical vessel (A) (5.0-cm inner diameter, 51 cm deep) was prepared and weighed (W₃ (g)). Then a cylindrical cell cap (B) (5.2 cm in diameter, 5.0 cm high) which was open at both ends was attached to the cylindrical vessel (A) to prepare the measuring instrument (C).

In a polyethylene bag (No. 12, 0.03-mm film thickness, 230 mm wide, 340 mm long), 30 g of hollow particles were weighed and the bag was closed with a rubber band at 100 mm from the mouth. Then the bag was quickly swung up and down ten times with the swing width of 200 mm to fluidize the hollow particles well. Then the hollow particles were filled into the instrument (C) by gently dropping the microspheres from the mouth of the bag 30 mm above the upper end of the cell cap (B) of the instrument (C). The particles were filled into the instrument (C) soon after the fluidization.

After filling the hollow particles into the instrument (C), the instrument was stood still for 2 min. Then the cell cap (B) was removed from the vessel (A) and the hollow particles overflowing from the vessel (A) were removed. The hollow particles adhering to the outside of the vessel (A) was also removed. The vessel (A) filled with the hollow particles was weighed (W₄ (g)).

The weights, W3 and W₄, were introduced in the following formula to calculate the aerated bulk density (d₂) of the hollow particles.

$${d}_{2} = ( {W}_{4} - {W}_{3} ) / 100$$

### Measurement of pH of the Aqueous Dispersion Containing 1 wt % of Hollow Particles

To 99 g of ion-exchanged water, 1 g of hollow particles was added and the mixture was agitated with a three-one motor at 150 rpm for 10 min, during which the temperature of the mixture was adjusted at 25° C., to be prepared into an aqueous dispersion.

The pH of the resultant aqueous dispersion was measured with a pH meter (D-71) manufactured by Horiba, Ltd.

### Handling Property of Hollow Particles Evaluated by Settling Time

At first, the technical reason of selecting the settling time of hollow particles for evaluating the handling property of the hollow particles is explained.

Usually substances having low true specific gravity have slow settling rate while substances having high specific gravity have fast settling rate. Substances having low true specific gravity are considered to have poor handling property because they remain longer time in the air until they fall on the ground and are more frequently flown by slight air current. Thus the settling time has been selected as the indicator of the handling property of the hollow particles of the present invention.

When a substance is falling, its terminal velocity, in other words, the time required for its settling, varies depending on the particle size of the substance because of the influence by gravity and air resistance. Naturally agglomerates of hollow particles have higher mass and faster terminal velocity and requires longer time to reach the terminal velocity comparing to isolated hollow particles. In other words, the settling time of hollow particles changes depending on their state of agglomeration or isolation. Thus the handling property of hollow particles can be evaluated by their settling time.

The handling property of hollow particles was tested and evaluated as follows.

A 1-L glass measuring cylinder (70 mm in outer diameter, 420 mm high) was prepared. A sample of hollow particles was weighed to the weight (W₅ g) calculated from the aerated bulk density of 300 ml of the particles (W₅=300/d₂) and placed in the measuring cylinder.

Then the following action was carried out rapidly.

The measuring cylinder was enclosed with a cap and inverted 5 times to fluidize the particles, checking that all the particles in the cylinder completely fell down each time. Then the settling of the particles to the 300-ml gauge line of the cylinder was confirmed. After that, the measuring cylinder was inverted and the time required for the settling of the particles to the 320-ml gauge line was measured.

The handling property of the particles was evaluated according to the following criteria based on the measured settling time (T4).
Good: T₄≤30 sec
Poor: T₄>30 sec

### Dispersibility of Hollow Particles

A sample of hollow particles was weighed to the weight (W₆ g) calculated from the true specific gravity of 45 cm³ of the particles (W₆=45/d₁) and placed in a 350-mL vessel. To the particles, 100 g of ethylene-vinyl acetate emulsion (SUMIKA FLEX 456HQ, having true specific gravity of 1.08 g/cm³) was added and lightly mixed manually. Then the mixture was agitated with a homogenizing disper manufactured by PRIMIX Corporation at 500 rpm for 2 min to be prepared into a compound.

The compound was formed into a coating film (5 cm long, 30 cm wide) by applying the compound on a surface with a coater having 0.2-mm gap. After drying the film, the number (N) of agglomerates on the surface of the film was counted and the dispersibility of the hollow particles was evaluated according to the following criteria
Good: N≤2
Poor: N>2

The hollow particles were evaluated overall according to the following criteria.
Good: good handling property and good dispersibility
Poor: good handling property and poor dispersibility
Poor: poor handling property and good dispersibility
Poor: poor handling property and poor dispersibility

### Example of Production A

An aqueous dispersion medium was prepared by adding 0.9 parts of polyvinylpyrrolidone, 0.1 part of sodium salt of carboxymethylated polyethyleneimine and 38 parts of colloidal silica A dispersion (mean particle size of 12 nm, 20-% effective concentration) to 750 parts of ion-exchanged water and adjusting its pH to 3.

An oily mixture was prepared by dissolving and mixing 137 parts of acrylonitrile, 91 parts of methacrylonitrile, 12 parts of methyl methacrylate, 1 part of diethylene glycol dimethacrylate, 3 parts of di(2-ethylhexyl) peroxydicarbonate, 36 parts of isobutane and 9 parts of isopentane.

The aqueous dispersion medium and the oily mixture were mixed and agitated with a homogenizing mixer (TK Homomixer, manufactured by PRIMIX Corporation) at 10,000 rpm for 1 min to be prepared into a suspension. Then the suspension was transferred into a compressive reactor of 1.5-liter capacity, purged with nitrogen and polymerized at 60° C. with the initial reaction pressure of 0.35 MPa for 20 hours with agitation at 80 rpm to be processed into the polymerization liquid A.

### Examples of Production B to E

In Examples of production B to E, the polymerization liquids B to E were prepared in the same manner as that in Example of production A, except that the reaction parameters were changed as shown in Table 1. The colloidal silica B dispersion used in Example of production E has the mean particle size of 7 nm and 20-% effective concentration.

### Example 1

The resultant polymerization liquid A was filtered and the wet cake on the filter was dried at 40° C. for 24 hours to be processed into the heat-expandable microspheres A. The ash content of the heat-expandable microspheres A was 2.2%. The properties of the heat-expandable microspheres A are shown in Table 1.

Then the heat-expandable microspheres A were processed into hollow particles by dry thermal expansion.

The dry thermal expansion was conducted by the internal injection process disclosed in Japanese Patent Application Publication 2006-213930. Specifically, the heat-expandable microspheres were processed into hollow particles by thermal expansion with the manufacturing device having the expansion unit as shown in FIG. 2 in the procedure mentioned below.

### Expansion Unit of the Manufacturing Device

As shown in FIG. 2, the expansion unit has the gas inlet tube (not indicated by a number) having the distribution nozzle (11) at its outlet and placed at the center of the part, the collision plate (12) disposed below the distribution nozzle (11), the overheat protection jacket (10) disposed around the gas inlet tube with a clearance from the tube, and the hot air nozzle (8) disposed around the overheat prevention jacket (10) with a clearance from the jacket. A gas fluid (13) containing heat-expandable microspheres runs through the gas inlet tube in the direction of the arrow, and a gas flow (14) runs through the space between the gas inlet tube and the overheat prevention jacket (10) in the direction of the arrows in order to improve the distribution of the heat-expandable microspheres and prevent overheat of the gas inlet tube and collision plate. Furthermore, a hot airflow (15) runs through the space between the overheat protection jacket (10) and the hot air nozzle (8) in the direction of the arrows in order to thermally expand the heat-expandable microspheres. The hot airflow (15), the gas fluid (13) and the gas flow (14) usually run in the same direction. A refrigerant flow (9) runs in the overheat prevention jacket (10) in the direction of the arrows in order to cool the jacket.

### Operation of the Manufacturing Device

In the injection step, the gas fluid (13) containing heat-expandable microspheres is introduced in the gas inlet tube having the distribution nozzle (11) at its outlet and placed at the inside of the hot airflow (15), and the gas fluid (13) is injected from the distribution nozzle (11).

In the distribution step, the gas fluid (13) collides with the collision plate (12) disposed below the distribution nozzle (11) and the heat-expandable microspheres are uniformly distributed in the hot airflow (15). The gas fluid (13) injected from the distribution nozzle (11) is led to the collision plate (12) along with the gas flow (14) and collides with the collision plate.

In the expansion step, the distributed heat-expandable microspheres are heated and expanded in the hot airflow (15) at a temperature higher than their expansion-initiation temperature. Then the resultant hollow particles are cooled and collected.

### Expansion Condition and Result

In Example 1, hollow particles 1 were manufactured by thermally expanding heat-expandable microspheres with the manufacturing device shown in FIG. 2, with the expansion parameters including the feeding rate of heat-expandable microspheres at 0.5 kg/min, the flow rate of the gas fluid for distributing heat-expandable microspheres at 0.35 m³/min, the flow rate of the hot airflow at 8.0 m³/min and the temperature of the hot airflow at 270° C. The resultant hollow particles 1 had a true specific gravity (d₁) of 0.025 and an aerated bulk density (d₂) of 0.0084. Other properties of the hollow particles 1 are shown in Table 2.

### Example 2

In Example 2, hollow particles 2 were manufactured by thermally expanding the heat-expandable microspheres A with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 240° C. The resultant hollow particles 2 had a true specific gravity (d₁) of 0.05 and an aerated bulk density (d₂) of 0.02. Other properties of the hollow particles 2 are shown in Table 2.

### Example 3

Wet cake containing 62% of solid was obtained by filtering the resultant polymerization liquid A.

To 1300 g of ion-exchanged water, 450 g of the wet cake was added and agitated at 200 rpm for 3 hours to be prepared into the redispersed liquid A. The redispersed liquid A was filtered and the wet cake on the filter was dried at 40° C. for 24 hours to be prepared into the heat-expandable microspheres A-1. The ash content of the heat-expandable microspheres A-1 was 1.7%. Other properties of the heat-expandable microspheres A-1 were the same as that of the heat-expandable microspheres A.

Then hollow particles 3 were manufactured by thermally expanding the heat-expandable microspheres A-1 with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 200° C. The resultant hollow particles 3 had a true specific gravity (d₁) of 0.09 and an aerated bulk density (d₂) of 0.0348. Other properties of the hollow particles 3 are shown in Table 2.

### Examples 4 and 5

The pH of 1000 g of the resultant polymerization liquid A was adjusted by adding 8 g of potassium hydroxide aqueous solution (50-% concentration) and agitating at 25° C. and 200 rpm for 1 hour. The pH of the polymerization liquid A after the adjustment was 11.2. The polymerization liquid A after the pH adjustment was filtered and 450 g of the resultant wet cake containing 62% of solid was washed with 450 g of ion-exchanged water. The dispersion after the washing was filtered and the wet cake on the filter was dried at 40° C. for 24 hours to be prepared into the heat-expandable microspheres A-2. The ash content of the heat-expandable microspheres A-2 was 0.2%. Other properties of the heat-expandable microspheres A-2 were the same as that of the heat-expandable microspheres A.

Then hollow particles 4 were manufactured by thermally expanding the heat-expandable microspheres A-2 with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 265° C. The resultant hollow particles 4 had a true specific gravity (d₁) of 0.03 and an aerated bulk density (d₂) of 0.0074. Other properties of the hollow particles 4 are shown in Table 2.

Hollow particles 5 were manufactured by thermally expanding the heat-expandable microspheres A-2 with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 205° C. The resultant hollow particles 5 had a true specific gravity (d₁) of 0.086 and an aerated bulk density (d₂) of 0.025. Other properties of the hollow particles 5 are shown in Table 2.

### Examples 6 and 7

The pH of 1000 g of the polymerization liquid B obtained in Example of production B was adjusted by adding 8.5 g of potassium hydroxide aqueous solution (50-% concentration) and agitating at 25° C. and 200 rpm for 1 hour. The pH of the polymerization liquid B after the adjustment was 11.5.

The polymerization liquid B after the pH adjustment was filtered and 450 g of the resultant wet cake containing 62% of solid was washed with 450 g of ion-exchanged water. The dispersion after the washing was filtered and the wet cake on the filter was dried at 40° C. for 24 hours to be prepared into the heat-expandable microspheres B-2. The ash content of the heat-expandable microspheres B-2 was 0.1%. Other properties of the heat-expandable microspheres B-2 were the same as that of the heat-expandable microspheres B.

Then hollow particles 6 were manufactured by thermally expanding the heat-expandable microspheres B-2 with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 285° C. The resultant hollow particles 6 had a true specific gravity (d₁) of 0.025 and an aerated bulk density (d₂) of 0.0058. Other properties of the hollow particles 6 are shown in Table 2.

Hollow particles 7 were manufactured by thermally expanding the heat-expandable microspheres B-2 with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 265° C. The resultant hollow particles 7 had a true specific gravity (d₁) of 0.055 and an aerated bulk density (d₂) of 0.015. Other properties of the hollow particles 7 are shown in Table 2.

### Comparative Example 1

The heat-expandable microspheres A produced in Example 1 were processed into hollow particles by dry thermal expansion.

Hollow particles 8 were manufactured by thermally expanding the heat-expandable microspheres A with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 310° C. The resultant hollow particles 8 had a true specific gravity (d₁) of 0.019 and an aerated bulk density (d₂) of 0.0034. Other properties of the hollow particles 8 are shown in Table 3.

### Comparative Example 2

The heat-expandable microspheres B-2 produced in Example 6 were processed into hollow particles by dry thermal expansion.

Hollow particles 9 were manufactured by thermally expanding the heat-expandable microspheres B-2 with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 315° C. The resultant hollow particles 9 had a true specific gravity (d₁) of 0.015 and an aerated bulk density (d₂) of 0.001. Other properties of the hollow particles 9 are shown in Table 3.

### Comparative Examples 3 and 4

The polymerization liquid C obtained in Example of production C was filtered and the wet cake on the filter was dried at 40° C. for 24 hours to be prepared into the heat-expandable microspheres C. The ash content of the heat-expandable microspheres C was 4.2%. Other properties of the heat-expandable microspheres C are shown in Table 1.

Then hollow particles 10 were manufactured by thermally expanding the heat-expandable microspheres C with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 325° C. The resultant hollow particles 10 had a true specific gravity (d₁) of 0.011 and an aerated bulk density (d₂) of 0.0021. Other properties of the hollow particles 10 are shown in Table 3.

Hollow particles 11 were manufactured by thermally expanding the heat-expandable microspheres C with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 300° C. The resultant hollow particles 11 had a true specific gravity (d₁) of 0.025 and an aerated bulk density (d₂) of 0.012. Other properties of the hollow particles 11 are shown in Table 3.

### Comparative Example 5

The polymerization liquid D obtained in Example of production D was filtered and the wet cake on the filter was dried at 40° C. for 24 hours to be prepared into the heat-expandable microspheres D. The ash content of the heat-expandable microspheres D was 2.2%. Other properties of the heat-expandable microspheres D are shown in Table 1.

In a separable flask, 50 parts of the heat-expandable microspheres D and 50 parts of calcium carbonate (Whiten SB Red, manufactured by Bihoku Funka Kogyo Co., Ltd.) were placed and mixed. Then the mixture was heated to 140° C. with agitation over 5 minutes to be manufactured into hollow particles 12. The resultant hollow particles 12 had a true specific gravity (d₁) of 0.044 and an aerated bulk density (d₂) of 0.0197. Other properties of the hollow particles 12 are shown in Table 3.

### Comparative Example 6

The pH of 1000 g of the polymerization liquid D obtained in Example of production D was adjusted by adding 7 g of potassium hydroxide aqueous solution (50-% concentration) and agitating at 25° C. and 200 rpm for 1 hour. The pH of the polymerization liquid D after the adjustment was 10.6

The polymerization liquid D after the pH adjustment was filtered and 450 g of the resultant wet cake containing 62% of solid was washed with 450 g of ion-exchanged water. The dispersion after the washing was filtered and the wet cake on the filter was dried at 40° C. for 24 hours to be prepared into the heat-expandable microspheres D-2. The ash content of the heat-expandable microspheres D-2 was 0.6%. Other properties of the heat-expandable microspheres D-2 were the same as that of the heat-expandable microspheres D.

Then hollow particles 13 were manufactured by thermally expanding the heat-expandable microspheres D-2 with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 330° C. The resultant hollow particles 13 had a true specific gravity (d₁) of 0.015 and an aerated bulk density (d₂) of 0.0028. Other properties of the hollow particles 13 are shown in Table 3.

### Comparative Example 7

The polymerization liquid E obtained in Example of production E was filtered and the cake on the filter was dried in an oven at 40° C. for 24 hours to be prepared into the heat-expandable microspheres E. The ash content of the heat-expandable microspheres E was 0.5%. Other properties of the heat-expandable microspheres E are shown in Table 1.

Then hollow particles 14 were manufactured by thermally expanding the heat-expandable microspheres E with the manufacturing device shown in FIG. 2, with the expansion parameters including the feeding rate of the heat-expandable microspheres at 0.5 kg/min, the flow rate of the gas fluid for distributing the heat-expandable microspheres at 0.35 m³/min, the flow rate of the hot airflow at 8.0 m³/min and the temperature of the hot airflow at 265° C. The resultant hollow particles 14 had a true specific gravity (d₁) of 0.02 and an aerated bulk density (d₂) of 0.0011. Other properties of the hollow particles 13 are shown in Table 3.

TABLE 1

| | | | Example of | Example of | Example of | Example of | Example of |
|---|---|---|---|---|---|---|---|
| | | | production | production | production | production | production |
| | | | A | B | C | D | E |
| Oily | Monomer | AN | 137 | 140 | 154 | 160 | 119 |
| mixture | component | MAN | 91 | 92.8 | 79 | 74 | 103 |
| (parts) | | MMA | 12 | | 4 | 4.8 | |
| | | St | | | 3 | | |
| | | IBX | | 7.2 | | | 16 |
| | Cross-linking | TMP | | | 1.3 | | |
| | agent | EDMA | 1 | 1.4 | | 1.2 | 0.79 |
| | Polymerization | OPP | 3 | | 3.5 | | |
| | initiator | AIBN | | | | 2.9 | 1.6 |
| | | V-65 | | 2.5 | | | |
| | Blowing agent | Isobutane | 36 | 35 | | | |
| | | Isopentane | 9 | 20 | 50 | 4.8 | 40 |
| | | Isooctane | | | 5 | 29 | |
| | | Isododecane | | | | 38 | |

| | | | | | | |
|---|---|---|---|---|---|---|
| Aqueous | Ion-exchanged water | 750 | 750 | 620 | 636 | 624 |
| dispersion | NaCl | | | 130 | 211 | |
| medium | Colloidal silica A dispersion | 38 | 30 | 67 | 34.5 | |
| (parts) | Colloidal silica B dispersion | | | | | 8 |
| | PVP | 0.9 | 0.9 | 0.7 | | 0.4 |
| | DEA-ADA | | | | 0.8 | |
| | CMPEI • Na salt | 0.1 | 0.1 | 0.1 | | |
| | AlCl₃ • 6H₂O | | | | | 0.12 |
| | Sodium nitrite | | | | 0.14 | |
| | pH of aqueous dispersion medium | 3 | 3 | 3 | 3.5 | 3 |
| Properties | Mean particle size (D50) | 9 | 16 | 22 | 45 | 7.5 |
| of heat- | Content of blowing agent (%) | 14.7 | 17.8 | 17.5 | 9.5 | 13.9 |
| expandable | Ash content (%) | 2.2 | 1.8 | 4.2 | 2.2 | 0.5 |
| microspheres | Expansion-initiation temp. (° C.) | 110 | 108 | 130 | 143 | 115 |
| | Maximum expansion temp. (° C.) | 140 | 152 | 175 | 183 | 155 |
| | Specific gravity at maximum expansion | 0.018 | 0.014 | 0.01 | 0.013 | 0.02 |

The abbreviations in Table 1 mean the following compounds.
AN: acrylonitrile
MIAN: methacrylonitrile
MMA: methyl methacrylate
St: styrene
IBX: isobornyl methacrylate
TMP: trimethylol propane trimethacrylate
EDMA: ethylene glycol dimethacrylate
OPP: di(2-ethylhexyl) peroxydicarbonate
AIBN: azobisisobutylonitrile
V-65: 2,2′-azobis(2,4-dimethylvarelonitrile)
NaCl: sodium chloride
PVP: polyvinyl pyrrolidone
DEA-ADA: diethanol amine-adipic acid condensate (50-% effective concentration)
CMPEI-Na salt: sodium salt of carboxymethylated polyethyleneimine
AlCl₃·6H₂O: aluminum chloride hexahydrate

TABLE 2

| | | Example | | | | | | |
|---|---|---|---|---|---|---|---|---|
| | | 1 | 2 | 3 | 4 | 5 | 6 | 7 |
| Hollow particles | | Hollow | Hollow | Hollow | Hollow | Hollow | Hollow | Hollow |
| | | particle 1 | particle 2 | particle 3 | particle 4 | particle 5 | particle 6 | particle 7 |
| Heat-expandable microspheres | | A | A | A-1 | A-2 | A-2 | B-2 | B-2 |
| Properties | True specific gravity d1 | 0.025 | 0.05 | 0.09 | 0.03 | 0.086 | 0.025 | 0.055 |
| of hollow | | | | | | | | |
| particles | Mean particle size (D50) | 32 | 25 | 21 | 30 | 22 | 55 | 44 |
| | Ash content (%) | 2.2 | 2.2 | 1.7 | 0.2 | 0.2 | 0.1 | 0.1 |
| | pH of 1-wt % dispersion | 7.2 | 7.2 | 7.2 | 8.6 | 8.6 | 9.2 | 9.2 |
| | Further expansion ratio | 28.0 | 64.0 | 80.0 | 40.0 | 79.1 | 44.0 | 74.5 |
| | Aerated bulk density d2 | 0.0084 | 0.02 | 0.0348 | 0.0074 | 0.025 | 0.0058 | 0.015 |
| | 100 × (d1 − d2)/d1 | 66.4 | 60.0 | 61.3 | 75.3 | 70.9 | 76.8 | 72.7 |

TABLE 3

| | | Comparative example | | | | | | |
|---|---|---|---|---|---|---|---|---|
| | | 1 | 2 | 3 | 4 | 5 | 6 | 7 |
| Hollow particles | | Hollow | Hollow | Hollow | Hollow | Hollow | Hollow | Hollow |
| | | particle 8 | particle 9 | particle 10 | particle 11 | particle 12 | particle 13 | particle 14 |
| Heat-expandable microspheres | | A | B-2 | C | C | D | D-2 | E |
| Properties | True specific gravity d1 | 0.019 | 0.015 | 0.011 | 0.025 | 0.044 | 0.015 | 0.02 |
| of hollow | Mean particle size (D50) | 35 | 65 | 97 | 75 | 160 | 176 | 27.8 |
| particles | Ash content (%) | 2.2 | 0.1 | 4.2 | 4.2 | 50.0 | 0.6 | 0.5 |
| | pH of 1-wt % dispersion | 7.2 | 9.2 | 7.3 | 7.3 | 7.1 | 8.1 | 7.1 |
| | Further expansion ratio | 5.3 | 6.7 | 9.1 | 60.0 | 40.9 | 13.3 | 0.0 |
| | Aerated bulk density d2 | 0.0034 | 0.001 | 0.0021 | 0.012 | 0.0197 | 0.0028 | 0.0011 |
| | 100 × (d1 − d2)/d1 | 82.1 | 93.3 | 80.9 | 52.0 | 55.2 | 81.3 | 94.5 |

### Evaluation

The lightweight property, handling property and dispersibility of the resultant hollow particles were tested and evaluated by the methods mentioned above. The results are shown in Tables 4 and 5.

The hollow particles of Examples 1 to 7 had a true specific gravity (d₁) within the range from 0.02 to 0.1 and satisfied the condition 1 mentioned above. Thus, the hollow particles were lightweight and had good handling property and dispersibility.

On the other hand, the hollow particles of Comparative Examples 1 to 3, 6 and 7 resulted in a value of the formula (I) of the condition 1 greater than 78, and the hollow particles strongly agglomerated or adhered due to fusing to each other without showing good dispersibility.

The hollow particles of Comparative Examples 4 and 5 resulted in a value of the formula (I) of the condition 1 smaller than 58, and the hollow particles did not form isolatable agglomerates. Thus, the hollow particles exhibited slower settling rate and longer settling time, was prone to scatter, and had poor handling property.

TABLE 4

| | | Example | | | Comparative example | | | | | |
|---|---|---|---|---|---|---|---|---|---|---|
| | | 1 | 4 | 6 | 1 | 2 | 3 | 4 | 6 | 7 |
| True specific gravity d1 | | 0.025 | 0.03 | 0.025 | 0.019 | 0.015 | 0.011 | 0.025 | 0.015 | 0.02 |
| 100 × (d1 − d2)/d1 | | 66.4 | 75.3 | 76.8 | 82.1 | 93.3 | 80.9 | 52.0 | 81.3 | 94.5 |
| Handling | Settling | 21 | 10 | 15 | 6 | 4 | 4 | 46 | 7 | 6 |
| property | time (s) | | | | | | | | | |
| | Evaluation | Good | Good | Good | Good | Good | Good | Poor | Good | Good |

| | | | | | | | | | |
|---|---|---|---|---|---|---|---|---|---|
| Dispersibility | Good | Good | Good | Poor | Poor | Poor | Good | Poor | Poor |
| Overall evaluation | Good | Good | Good | Poor | Poor | Poor | Poor | Poor | Poor |

TABLE 5

| | | Example | | | | Comparative |
|---|---|---|---|---|---|---|
| | | 2 | 3 | 5 | 7 | example 5 |
| True specific gravity d1 | | 0.05 | 0.09 | 0.086 | 0.055 | 0.044 |
| 100 × (d1 − d2)/d1 | | 60.0 | 61.3 | 70.9 | 72.7 | 55.2 |
| Handling | Settling | 12 | 7 | 6 | 10 | 35 |
| property | time (s) | | | | | |
| | Evaluation | Good | Good | Good | Good | Poor |

| | | | | | |
|---|---|---|---|---|---|
| Dispersibility | Good | Good | Good | Good | Good |
| Overall evaluation | Good | Good | Good | Good | Poor |

### INDUSTRIAL APPLICABILITY

The hollow particles of the present invention are usable as the lightweight filler for putties, paints, ink, sealing materials, mortar, paper clay and porcelains and the filler for foamed products which are molded in injection molding, extrusion molding and press molding to be processed into foamed products having good sound-insulation property, heat-insulation property, heat-shielding property and sound absorbency.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

1. Hollow particles comprising a thermoplastic resin shell and a hollow part surrounded by the shell,
wherein the hollow particles have a true specific gravity (d₁) ranging from 0.02 to 0.1; and
satisfy the condition 1 shown below:
Condition 1: The true specific gravity (d₁) and an aerated bulk density (d₂) of the hollow particles satisfy the following formula (I):
$$\begin{matrix}Formula ( I ) & \\ 58 ≦ 100 \times ( {d}_{1} - {d}_{2} ) / {d}_{1} ≦ 78 . & \end{matrix}$$

2. The hollow particles according to claim 1, wherein the ash content of the hollow particles is 2.5 wt % or less.

3. The hollow particles according to claim 1, wherein the hollow particles have a mean particle size ranging from 1 to 100 μm.

4. The hollow particles according to claim 1, wherein the thermoplastic resin is a polymer of a polymerizable component containing a nitrile monomer.

5. The hollow particles according to claim 1, wherein the hollow particles satisfy the condition 2 shown below:
Condition 2: The pH of the aqueous dispersion prepared by dispersing 1 wt % of the hollow particles in ion-exchanged water is higher than 7 at 25° C.

6. A composition comprising the hollow particles according to claim 1 and a base material.

7. A formed product manufactured by forming the composition according to claim 6.

8. The hollow particles according to claim 2, wherein the hollow particles have a mean particle size ranging from 1 to 100 μm.

9. The hollow particles according to claim 2, wherein the thermoplastic resin is a polymer of a polymerizable component containing a nitrile monomer.

10. The hollow particles according to claim 3, wherein the thermoplastic resin is a polymer of a polymerizable component containing a nitrile monomer.

11. The hollow particles according to claim 2, wherein the hollow particles satisfy the condition 2 shown below:
Condition 2: The pH of the aqueous dispersion prepared by dispersing 1 wt % of the hollow particles in ion-exchanged water is higher than 7 at 25° C.

12. The hollow particles according to claim 3, wherein the hollow particles satisfy the condition 2 shown below:
Condition 2: The pH of the aqueous dispersion prepared by dispersing 1 wt % of the hollow particles in ion-exchanged water is higher than 7 at 25° C.

13. The hollow particles according to claim 4, wherein the hollow particles satisfy the condition 2 shown below:
Condition 2: The pH of the aqueous dispersion prepared by dispersing 1 wt % of the hollow particles in ion-exchanged water is higher than 7 at 25° C.
